(19) United States
(12) Patent Application Publication
(10) Pub. No.: US 2012/0018929 A1
(43) Pub. Date: Jan. 26, 2012

(54) MODIFIED POLY(HYDROXYALKANOIC ACID) COMPOSITION

(76) Inventors: Julius Uradnisheck, (US); Jose Maria Torradas, (US)

(21) Appl. No.: 13/251,655

(22) Filed: Oct. 3, 2011

Related U.S. Application Data
(63) Continuation of application No. 12/510,739, filed on Jul. 28, 2009.

(51) Int. Cl. B29C 49/10

(52) U.S. Cl. 264/531

(57) ABSTRACT

Disclosed is a process for preparing injection stretch blow molded containers from poly(hydroxyalkanoic acid) compositions comprising a poly(hydroxyalkanoic acid), an ethylene ester copolymer, and a nucleator.

The invention relates to injection stretch blow molded containers prepared from thermoplastic compositions comprising a poly(hydroxyalkanoic acid) having improved toughness, dimensional stability, and stretchability.

### BACKGROUND OF THE INVENTION

Containers such as bottles and jars are often molded from thermoplastic resins in an injection stretch blow molding process (ISBM). In an ISBM process, the polymer resin is heated to the molten form in an extruder and then injection-molded in a mold to provide a “preform”. The preform is then heated and stretched or expanded by application of air pressure to its final shape.

Containers are often desirably clear and are commonly used to package drinks such as water and carbonated beverages. Poly(ethylene terephthalate) (PET) bottles perform very well in this application, but has the drawbacks of being derived from oil-based materials and of not being biodegradable or compostable. There is an increasing interest in developing substitute polymeric materials that are derived from annually-renewable resources. Biodegradable or compostable materials are also of interest, because they break down relatively quickly if landfilled or composted under proper conditions. Containers made from biodegradable materials can be disposed of as well as recycled, and thus provide a wider range of disposal/reuse options.

Poly(hydroxyalkanoic acid) (PHA), such as polylactide (polylactic acid or PLA) can be produced from renewable monomers, are biodegradable, and can be produced from annually renewable resources such as corn, rice or other sugar- or starch-producing plants.

However, physical limitations such as brittleness and slow crystallization may limit the applications of PHA. Numerous impact modifiers have been developed in the past to improve the toughness of PHA (see, e.g., JP9316310, U.S. Pat. Nos. 7,381,772 and 7,354,973, and US 2007/0213466A1 and US2006/0173133A1; e.g., a terpolymer having copolymerized units of ethylene, butyl acrylate and glycidyl methacrylate (EBAGMA) is used as an impact modifier). Nucleating agents have been developed to increase the crystallinity or rate of crystallization for PHA (e.g., U.S. Pat. No. 6,417,294, US2008/0306185A1, US2009/0069509A1, and U.S. Pat. No. 7,301,000).

Use of PLA resins in an ISBM process has been proposed to produce containers (e.g., U.S. Pat. No. 5,409,751). However, PLA resins are difficult to process in ISBM processes, as the PLA resins tend to have significantly different crystalline properties and much smaller processing windows than PET. PLA resins have been difficult to process at high operating rates into good quality bottles. In some instances, the resin cannot be blown well at all. In other cases, the resin may stress whiten during the molding process, forming opaque rather than clear containers. Containers may have a considerable lack of uniformity in the container wall thickness and/or have poor impact strength. As a result, the processing window that can be used to make injection stretch molded containers from PLA resins has been so narrow that PLA resins have not been used successfully in ISBM processes to date. See, also, US2007/0187876A1.

It is desirable to provide a method by which PHA-containing resins can be used to produce containers in an ISBM process at good operating rates to produce good quality containers. There is a need for containers prepared from a PHA composition that has adequate stretchability for ISBM operations and which provides desirable toughness and dimensional stability for the finished container.

### SUMMARY OF THE INVENTION

A process that can be used for preparing a shaped article comprising, consisting essentially of, or consisting of preparing a thermoplastic composition; heating the composition to a melt; molding the melt in a first mold into a substantially tubular hollow preform; bringing the preform to a temperature between the Tg and the temperature of crystallization from the glass or cold crystallization of the composition; and stretching the preform in the presence of a second mold wherein

the composition comprises, consists essentially of, consists of, or is produced from, based on the weight of the composition, about 50 to about 99.5% of a PHA, about 0.1 to about 40% of an ethylene ester copolymer, and about 0.05 to about 5% of a nucleator;

the ethylene ester copolymer comprises, based on the total weight of the ethylene ester copolymer, about 20 to about 95% of copolymerized units of ethylene, about 0.5 to about 25% of copolymerized units of one or more olefins of the formula CH₂═C(R¹)CO₂R², and 0 to about 70% of copolymerized units of one or more olefins of the formula CH₂═C(R³)CO₂R⁴;

R¹ is hydrogen or an alkyl group with 1 to 6 carbon atoms;

R² is glycidyl, based on the total weight of the ethylene ester copolymer;

R³ is hydrogen or an alkyl group with 1 to 8 carbon atoms;

R⁴ is an alkyl group with 1 to 8 carbon atoms, carbon monoxide, or of two or more combinations thereof;

the nucleator is a carboxylic acid or derivative thereof that does not cause PHA depolymerization;

the preform has one closed end and one open end;

the stretching can be carried out in axial direction, radial direction, or a combination thereof;

the second mold has interior dimensions greater than the external dimensions of the preform and equal to the external size and shape of a desired final shaped article; and

the stretching is carried out by application of air pressure and mechanical pressure to the interior of the preform to provide the shaped article with external dimensions complementary to the internal dimensions of the mold.

The invention is further directed to shaped articles, including injection molded preforms and blown bottles comprising or produced using the process and composition described above.

### DETAILED DESCRIPTION OF THE INVENTION

In ISBM process for making containers of a thermoplastic resin, a thermoplastic resin melt is injected into a cold mold for rapid quenching into a preform of substantially amorphous polymer which is then heated above the Tg but not to the melting point and mechanically stretched-and blown and expanded into a container mold to stretch the preform axially 50% to 400% and radially 100% to 600% and form a container. ISBM may be either a one-step or two-step process.

The ISBM process involves the production of hollow objects, such as bottles, jars and other containers having biaxial molecular orientation (radial and axial). Biaxial orientation provides enhanced physical properties such as higher mechanical strength and rigidity, clarity (transparency), and gas barrier properties, which are all very desirable in products such as bottles, vials, jars and other containers. Biaxial orientation allows bottles to resist deforming under the pressures formed by carbonated beverages, which may approach 60 psi.

Stretchability of films made the polymer compositions may be determined by measuring the percent elongation at break of a sheet made of the polymer composition to be tested. The “percent elongation at break” refers to the difference between the length of the sheet at the time of sheet rupture under an applied force and the length of the sheet in its undeformed or unstrained state, divided by the length of the sheet in its undeformed or unstrained state. In the present invention, the percent elongation at break is measured in accordance with ASTM D-638.

The addition of the ethylene ester copolymer and the aliphatic carboxylic acid amide can increase the percent elongation at break of a PHA composition by at least two-fold, preferably about two-fold to about twenty-five-fold. This improved elongation to break allows for the modified composition to be used in ISBM processes.

The PHA polymers may be prepared by polymerization of hydroxyalkanoic acids having 2 to 7 carbon atoms. Examples of hydroxyalkanoic acids include 6-hydroxyhexanoic acid, 3-hydroxyhexanoic acid, 4-hydroxyhexanoic acid, 3-hydroxyheptanoic acid, glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, and 5-hydroxyvaleric acid, or combinations of two or more thereof. For example, the poly(hydroxyalkanoic acids) may be prepared by polymerization of 6-hydroxyhexanoic acid (also known as polycaprolactone (PCL)), 3-hydroxyhexanoic acid, 4-hydroxyhexanoic acid, or 3-hydroxyheptanoic acid. The PHA is preferably derived from the polymerization of hydroxyalkanoic acids (or esters thereof) having 2 to 5 carbon atoms, such as, glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, or 5-hydroxyvaleric acid.

The PHA may be homopolymers or copolymers comprising at least one comonomer derived from a hydroxyalkanoic acid or a derivative thereof. By derivative is meant a hydroxyalkanoate or a cyclic dimer (e.g., a lactide dimer) derived from the reaction between two hydroxyalkanoic acids. Blends of such polymers are also useful in the practice of the invention.

For example, the PHA polymer may be a blend of copolymers of such as poly(hydroxybutyric acid-hydroxyvaleric acid) copolymers and poly(glycolic acid-lactic acid) copolymers. Such copolymers can be prepared by catalyzed copolymerization of a PHA or derivative with one or more comonomers derived from cyclic esters and/or dimeric cyclic esters. Such esters may include glycolide (1,4-dioxane-2,5-dione); the dimeric cyclic ester of glycolic acid; lactide (3,6-dimethyl-1,4-dioxane-2,5-dione); α,α-dimethyl-β-propiolactone; the cyclic ester of 2,2-dimethyl-3-hydroxy-propanoic acid; β-butyrolactone; the cyclic ester of 3-hydroxybutyric acid; δ-valerolactone; the cyclic ester of 5-hydroxypentanoic acid; ε-capro-lactone; the cyclic ester of 6-hydroxyhexanoic acid; the lactone of the methyl substituted derivatives of 6-hydroxyhexanoic acid (such as 2-methyl-6-hydroxyhexanoic acid, 3-methyl-6-hydroxyhexanoic acid, 4-methyl-6-hydroxyhexanoic acid, 3,3,5-trimethyl-6-hydroxyhexanoic acid, and etc.); the cyclic ester of 12-hydroxy-dodecanoic acid and 2-p-dioxanone; and the cyclic ester of 2-(2-hydroxyethyl)-glycolic acid.

The PHA polymers may also be copolymers of one or more hydroxyalkanoic acid monomers or derivatives with other comonomers, such as aliphatic and aromatic diacid and diol monomers (e.g., succinic acid, adipic acid, terephthalic acid, ethylene glycol, 1,3-propanediol, and 1,4-butanediol).

Of note are PHA selected from the group consisting of poly(glycolic acids), poly(lactic acids), poly(hydroxybutyric acids), poly(hydroxybutyric acid-hydroxyvaleric acid) copolymers, and poly(glycolic acid-lactic acid) copolymers. Preferably, the PHA is selected from poly(glycolic acid), poly(lactic acid) (PLA), poly(hydroxybutyrate) and combinations of two or more of these polymers. More preferably, the PHA is a PLA having a number average molecular weight (Mₙ) of about 3,000 to about 1,000,000. Preferably Mₙ is about 10,000 to about 700,000, more preferably about 20,000 to about 600,000.

The PLA may be a homopolymer or a copolymer containing at least about 50 mol %, or at least about 70 mol %, or at least about 90 mol % of copolymerized units derived from lactic acid or derivatives thereof. The PLA homopolymers or copolymers can be prepared from the two optical monomers D-lactic acid and L-lactic acid, or a mixture thereof (including a racemic mixture thereof). Either D- or L-lactic acid can be produced in synthetic processes, whereas fermentation processes usually (but not always) tend to favor production of the L enantiomer. The PLA copolymer may be a random copolymer or a block copolymer or a stereo block copolymer or a stereo complex between optical blocks. For example, the PLA copolymer may be the stereo complex of about 50% of poly(D-lactic acid) and about 50% of poly(L-lactic acid). Alternatively, the PLA copolymer may be a copolymer in which the average enantiomer ratios may be from 70:30 to 97:3 or greater, such as from 80:20 to 90:10 or 95:3 or greater. Blends of copolymers having different enantiomer ratios may also be used to provide a resin with an enantiomer ratio in a desired range. Of note are compositions (either copolymers or blends) wherein one enantiomer constitutes 90-99.5% of the polymerized lactic acid units and the other enantiomer constitutes from 0.5 to 10% of the polymerized lactic acid units.

The PHA may be prepared by any suitable process such as by a direct dehydration-polycondensation process which involves the dehydration and condensation of the hydroxyalkanoic acid(s) in the presence of an organic solvent and catalyst (see e.g., U.S. Pat. Nos. 5,310,865 and 5,401,796). A PHA may also be synthesized through the dealcoholization-polycondensation of an alkyl ester of polyglycolic acid or by ring-opening polymerization of a cyclic derivative such as the corresponding lactone or cyclic dimeric ester (see e.g., U.S. Pat. No. 2,703,316). A preferred lactide is produced by polymerizing lactic acid to form a prepolymer, and then depolymerizing the prepolymer and simultaneously distilling off the lactide that is generated, described in U.S. Pat. No. 5,274,073.

PHA polymers may also be synthesized in vivo by living organisms or isolated from plant matter. Numerous microorganisms have the ability to accumulate intracellular reserves of PHA polymers. See, e.g., U.S. Pat. No. 6,323,010.

The ethylene copolymer can be made by copolymerizing units (monomers) of (a) ethylene; (b) one or more olefins of the formula CH₂═C(R¹)CO₂R² where R¹ is hydrogen or an alkyl group with 1 to 6 carbon atoms, such as methyl, and R² is glycidyl; and optionally (c) one or more olefins of the formula CH₂═C(R³)CO₂R⁴, where R³ is hydrogen or an alkyl group with 1 to 8 carbon atoms and R⁴ is an alkyl group with 1 to 8 carbon atoms, such as methyl, ethyl, or butyl, carbon monoxide, or combinations thereof. Copolymerized units derived from monomer (a) may comprise, based on the copolymer weight, from about 20, 40 or 50% to about 80, 90 or 95%. Copolymerized units derived from monomer (b) may comprise, based on the copolymer weight, from about 0.5, 2 or 3% to about 17, 20, or 25%. An example of the ethylene copolymer consists essentially of copolymerized units of ethylene and copolymerized units of glycidyl methacrylate and is referred to as EGMA. Optional monomers (c) may be butyl acrylates or CO. One or more of n-butyl acrylate, tert-butyl acrylate, iso-butyl acrylate, and sec-butyl acrylate may be used. An ethylene copolymer example consists essentially of copolymerized units of ethylene, copolymerized units of butyl acrylate, and copolymerized units of glycidyl methacrylate (EBAGMA) as well as of ethylene, copolymerized units of methacrylate, and copolymerized units of glycidyl methacrylate (EMAGMA). Copolymerized units derived from monomer (c), when present, may comprise, based on the copolymer weight, from about 3, 15 or 20% to about 35, 40 or 70%.

The ethylene ester copolymers may additionally comprise other comonomers such as carbon monoxide. When present, copolymerized units of carbon monoxide generally will comprise up to about 20 wt %, or about 3 to about 15 wt % of the total weight of the ethylene ester copolymer.

The ethylene ester copolymers may be prepared by any suitable process such as those disclosed in U.S. Pat. Nos. 3,350,372; 3,756,996; 5,532,066; 5,543,233; and 5,571,878). Alternatively the ethylene copolymer may be a glycidyl methacrylate grafted ethylene copolymer or polyolefin, wherein an existing ethylene copolymer such as ethylene/methyl acrylate copolymer or a polyolefin such as polyethylene is reacted with glycidyl methacrylate to provide a copolymer with units derived from glycidyl methacrylate pendant from the polymer chain.

The PHA composition may comprise 0.05 to about 5%, about 0.1 to about 4%, about 0.5 to about 4%, about 1 to about 4%, about 0.5 to about 3%, about 1 to about 3%, or about 1 to about 2%, based on the weight of the composition, a nucleator, which can include a carboxylic acid or derivative thereof that does not cause PHA depolymerization. The carboxylic acid or its derivative can include aromatic carboxylic acid (e.g., benzoic acid); aliphatic carboxylic acid (e.g., unsaturated fatty acid such as oleic acid; saturated fatty acid such as stearic acid and behenic acid; fatty acid alcohol (an alcohol prepared from a fatty acid by reduction) such as stearyl alcohol; fatty acid aliphatic carboxylic acid ester such as butyl stearate; and aliphatic carboxylic acid amide such as stearamide, ethylene bis-stearamide or behenamide; polycarboxylic acid; aliphatic hydroxycarboxylic acid; or combinations of two or more thereof. Wishing not to be bound by theory, injection blow molded articles made from a PHA composition comprising long chain (e.g., 31 carbons) fatty acids or derivatives may be less optically clear due to possible difficulty in dispersing these compounds or due to less solubility of these compounds in PHA such as above about 2% and due to a mismatch of refractive indices of the PHA and additives.

The carboxylic acids or their derivatives can be aliphatic, mono-functional (saturated, unsaturated, or multi-unsaturated) carboxylic acids or derivatives thereof. The acid may have from about 10 to about 30, about 12 to about 28, about 16 to about 26, or 18 to 22, carbon atoms per molecule. Of particular interest are those on the US Food and Drug Administration (FDA) list as GRAS (generally regarded as safe) or having food contact status. The carboxylic acid derivatives may have a low volatility (do not volatilize at temperatures of melt blending with PHA) when being melt-blended with PHA or have particles that can well dispersed in PHA such as those having diameters less than about 2_{μ} or are non-migratory (do not bloom to the surface of PLA under normal storage conditions (ambient temperatures)). That is, a desired carboxylic acid or derivative has a boiling point higher than the melt processing temperature and pressure of PHA, which is disclosed elsewhere in the application.

Examples of carboxylic acid nucleators include lauric acid, palmitic acid, stearic acid, behenic acid, erucic acid, oleic acid, linoleic acid, or combinations of two or more thereof.

Fatty acid ester nucleators include alkyl esters of a fatty acid (an aliphatic arboxlic acid) where the alkyl ester moiety has 1 to 30, 4 to 30, 1 to 20, 4 to 20, or 10 to 20 carbon atoms and the fatty acid moiety has from 10 to 30, 12 to 28, 16 to 26, or 18 to 22, carbon atoms. Examples include C₁ to C₈, preferably C₁ to C₄, alkyl esters of lauric, palmitic, stearic, erucic, oleic, linoleic, or behenic acids.

Aliphatic carboxylic acid amides suitable for use as the nucleator component of the compositions are amides of aliphatic carboxylic acids wherein the acid has 10 to 30 carbon atoms, preferably 12 to 28 carbon atoms, more preferably 16 to 26 carbon atoms, and most preferably 18 to 22 carbon atoms.

Aliphatic carboxylic acid amides which are useful in the composition include, but are not limited to a) aliphatic monocarboxylic acid amides (e.g., lauramide, palmitamide, oleamide, stearamide, erucamide, behenamide, ricinolamide, hydroxystearamide), b) N-substituted aliphatic monocarboxylic acid amides (e.g., N-oleylpalmitamide, N-oleyloleamide, N-oleylstearamide, N-stearyloleamide, N-stearylstearamide, N-stearylerucamide, methylolstearamide, methylolbehenamide), c) aliphatic carboxylic acid bisamides (e.g., methylenebisstearamide, ethylenebislauramide, ethylenebiscapramide, ethylenebisoleamide, ethylenebisstearamide, ethylenebiserucamide, ethylenebisbehenamide, ethylenebisisostearamide, ethylenebishydroxystearamide, butylenebisstearamide, hexamethylenebisoleamide, hexamethylenebisstearamide, hexamethylenebisbehenamide, hexamethylenebis hydroxystearamide, m-xylylenebisstearamidei, m-xylylenebis-12-hydroxystearamide), d) N-substituted aliphatic carboxylic acid bisamides (e.g., N,N′-dioleylsebacamide, N,N′-dioleyladipamide, N,N′-distearyladipamide, N,N′-distearylsebacamide), and e) N-substituted ureas (e.g., N-butyl-N′-stearylurea, N-propyl-N′-stearylurea, N-allyl-N′-stearylurea, N-phenyl-N′-stearylurea, xylylenebisstearylurea, tolylenebisstearylurea, hexamethylenebisstearylurea, diphenylmethanebisstearylurea, diphenylmethanebislaurylurea). These aliphatic carboxylic acid amides can be used singly or as a mixture.

Examples of nucleators include lauramide, palmitamide, stearamide, erucamide, oleamide, linoleamide, behenamide, arachidamide, ethylene bis-stearamide, or combinations of two or more thereof.

The aliphatic carboxylic acid amide can be a monocarboxylic acid amide such as is selected from erucamide, behenamide, stearamide, and combinations of two or more thereof.

The PHA compositions comprise about 50 to about 99.5 wt % of a PHA, about 0.1 to about 40 wt % of at least one ethylene ester copolymer, and about 0.05 to about 5 wt % of an aliphatic carboxylic acid amide, based on the total weight of the composition. Due to the addition of the ethylene ester copolymer and the aliphatic carboxylic acid amide, such PHA compositions possess not only desirable toughness or dimensional stability but also greatly improved stretchability.

The PHA compositions can comprise about 65 to about 99 wt %, or about 67 to about 99 wt %, or about 89 to about 99 wt %, of the PHA, based on the total weight of the composition. It is also preferred that the ethylene ester copolymer or copolymers be present in the PHA composition at a level of about 0.1 to about 30 wt %, or about 0.5 to about 20 wt %, or about 1 to about 10 wt %, based on the total weight of the composition. It is preferred that the aliphatic carboxylic acid amide is present in the PHA composition at a level of about 0.1 to about 3 wt %, or about 0.25 to about 1 wt %, based on the total weight of the composition.

In one particular embodiment, the composition comprises about 89 to about 99 wt % of PLA, about 1 to about 10 wt % of terpolymer having copolymerized units of ethylene, butyl acrylate, and glycidyl methacrylate and about 0.25 to about 1 wt % of behenamide, based on the total weight of the composition.

The compositions may also optionally further comprise other additives in amounts depending on the particular use. For example, the following additive levels are generally useful: about 0.5 to about 7 wt % of plasticizer; about 0.1 to about 2 wt % of antioxidants and stabilizers; about 0.5 to about 30 wt % of fillers; about 5 to about 40 wt % of reinforcing agents; and/or about 1 to about 30 wt % of flame retardants, based on the total weight of the composition. Examples of suitable fillers include glass microspheres or carbon black and minerals such as talc, and wollastonite. Of note is a composition consisting of about 50 to about 99.5 wt % of a PHA, about 0.1 to about 40 wt % of an ethylene ester copolymer, and about 0.05 to about 5 wt % of an aliphatic carboxylic acid amide and at least one additive as described above.

The composition may be prepared by blending the components by any means known to one skilled in the art, e.g., dry blending/mixing, extrusion, co-extrusion, to produce the composition. The composition may be a pellet blend or melt extruded blend. The composition may be prepared by a combination of heating and mixing (melt-mixing or melt-blending). For example, the component materials may be mixed to be substantially dispersed or homogeneous using a melt-mixer such as a single or twin-screw extruder, blender, Buss Kneader, double helix Atlantic mixer, Banbury mixer, roll mixer, etc., to give a resin composition. Alternatively, a portion of the component materials may be mixed in a melt-mixer, and the rest of the component materials subsequently added and further melt-mixed until substantially dispersed or homogeneous. For example, a salt and pepper blend of the components may be made and the components may then be melt-blended in an extruder. Alternatively, the components may be fed to the extruder separately and melt-blended.

Melt blending the PHA, the ethylene ester copolymer or copolymers, and the aliphatic carboxylic acid amide can be carried out until they are substantially homogeneously dispersed to a degree such that particles of any component polymer are not observed visually and no laminar morphology is formed when the composition is injection molded to form an article. If other additional additive materials are present they will preferably also be uniformly dispersed in the blend of PHA, ethylene ester copolymer and aliphatic carboxylic acid amide. Any melt-blending method known in the art may be used provided care is taken not to subject the composition to conditions that result in excessively high shear rates or localized long hold-up times because such conditions may result in generation of temperatures sufficient to decompose the PHA.

The composition may be processed into pellets by a combination of extruding the melt into a strand, cutting the strand and cooling. Cooling may be effected by exposure to cool air or water. For example, a Gala underwater pelletizing system may be used to pelletize the extrudates into small pellet size.

Alternatively, the composition may be passed directly from the extruder into an injection molding apparatus as a melt. The first and second steps of the process may be accomplished in a continuous operation, eliminating the need for a second heating operation.

The compositions can be used in an ISBM process by preparing injection molded preforms for subsequent ISBM into bottles, jars and other containers. ISBM processes are known, being described, for example, in U.S. Pat. No. 5,409,751.

The process involves forming a hollow perform. The composition can be heated to a melt and molded into a shaped preform by injection molding. A preform is a substantially tubular hollow article having a closed end and an open end with relatively thick walls and volume dimensions a fraction of those of the final container, which is adapted for subsequent blow molding into a finally desired container form. The preform may be produced with the necks of the bottle, including threads or other means for attaching a closure (the “finish”) on one end. The preform desirably comprises an amorphous polymer composition to allow for orientation in a subsequent blowing step (see below).

Injection molding of preforms for later blow molding into container configurations may include some balancing of factors (See, e.g., Blow Molding Handbook, by Rosato and Rosato, Hanser Publishers, New York, N.Y., 1988). See also U.S. Pat. Nos. 5,914,138, 6,596,213, 5,914,138, and 6,596,213.

Injection molding a bottle preform may be conducted by transporting a molten material into a mold and allowing the molten material to cool. The mold includes a first cavity extending inwardly from an outer surface of the mold to an inner end, an article formation cavity, and a gate connecting the first cavity to the article formation cavity. The gate defines an inlet orifice in the inner end of the first cavity, and an outlet orifice that opens into the article formation cavity. The article formation cavity typically may be cylindrical (but other profiles are contemplated) with an axially centered projection at the end opposite the gate. The molten material flows through the gate into the cavity, filling the cavity. The molding provides an article that is substantially a tube with an “open” end and a “closed” end encompassing a hollow volume. The open end provides the neck of the bottle and the closed end provides the base of the bottle after subsequent blow molding. The molding may be such that various flanges and protrusions at the open end provide strengthening ribs and/or closure means, for example screw threads, for a cap.

Transporting the material extends from a melt source to the vicinity of the inlet orifice of the gate and includes an elongated bushing residing at least partially within the first cavity. This bushing defines an elongated, axial passageway therethrough that terminates at a discharge orifice. A “gate area” can be the assembled mold and bushing between the discharge orifice of the bushing and the outlet orifice of the gate.

During the injection of a melt, the melt may flow from the discharge orifice of the bushing, through the gap between the discharge orifice of the bushing and the inlet of the gate, through the gate, and into the article formation cavity of the mold. The preform mold is ideally maintained at a temperature below the minimum Tg of the polymer resin, which enables the polymer to be quenched in the amorphous phase. Because the temperature is maintained above the material's maximum crystal melt temperature in the bushing, and the temperature of the mold is maintained well below the Tg of the material, the majority of each shot cools quickly to its glassy state in the article formation cavity of mold. This results in the preform having low crystallinity levels (i.e., an article made up of substantially amorphous material) because the material temperature does not remain within its characteristic crystallization range for any appreciable length of time. Amorphous material allows the preform to be blow-molded into a desired shape easily and with a minimum of reheating, avoiding the formation of undesirable cracks or haziness in the finished article/preform caused by the presence of excessive crystallized material therein.

At the end of each “shot” injection pressure may be maintained on the melt for between about 1 and 5 seconds in order to assure that the melt is appropriately packed into the article formation cavity of the mold. Thereafter, the injection pressure on the melt is released, and the article may be allowed to cool in the mold for about 10 to 20 seconds. Subsequently, the mold is opened, the article is ejected therefrom, and the mold is re-closed. The latter operations may take on the order of about 10 seconds. The temperature of the melt material may transition in the gate area of the system/apparatus during the time interval between successive material “shots” between its molten phase temperature and its glassy (rigid) phase temperature in a controlled manner.

The preforms, and final shaped articles (such as bottles) prepared from the preforms, may comprise materials other than the PHA blend, such as layers of polymeric material other than the PHA blend. Additives disclosed above may be present in the respective layers.

Multilayer preforms may be prepared by coinjection molding wherein two (or more) melt streams are injected into a mold in such a way that one polymeric material is on the outside of the article while another polymer is in the inside. The molten materials may be injected into the mold from an annular die such that they form a laminar flow of concentric layers. For example, in a three-layer preform, the inside layer (the layer facing the hollow volume of the preform) and the outside layer (the layer remote from the hollow volume) comprise the PHA blend composition and the interior layer (a layer in which both faces of the layer are in contact with another layer) comprises a different material such as, for example, a barrier material. The molten materials are introduced into the mold such that the material for the outside layer and the inside layer enter the mold cavity before the material for the interior layer enters. Thus, the material for the outside and inside layer forms a leading edge of the laminar flow through the cavity. For a period of time, the three layers enter the mold cavity in a three-layer concentric laminar flow. Next, flow of the material for the interior layer is halted and the material for the outside and inside layers provides a trailing edge of the laminar flow. The flow continues until the entire cavity is filled and the trailing edge seals or fuses to itself at the gate area to form the closed end of the preform. The molding process for a three-material, four-layer preform is similar except that two different materials are provided for the two interior layers.

Positioning of the various layers in a cross-section of the preform may be adjusted by controlling relative volumetric flow rates of the inside and outside layers to enable relative shifting of the position of the core, and also the relative thickness of the inside and outside layers in the molded articles (see U.S. Pat. No. 6,596,213).

Molding of three materials to form a four-layer or five-layer object may include a plastic container comprising two interior layers (one layer selected for its gas barrier or gas scavenger properties, and the other layer for its UV protection or for some other property such as a structural layer or a recycled layer). In a 5-layer object, an additional interior structural layer may be between these interior layers. The leading edge of gas barrier and/or gas scavenger property may preferably be such that one of the two interior layers is uniform in its penetration around the circumference of the molded object. This uniform penetration may be achieved by starting the flow of this one interior layer before starting the flow of the second interior layer, so that the leading edge of this first-flowing interior layer starts on the zero gradient of the velocity profile. Subsequent initiation of the flow of the second interior layer offsets the later-flowing portions of the first interior material from the zero gradient, but the uniform leading edge is established by the initial flow of the first interior layer on the zero gradient.

The relative thickness and position of each of the interior layers may be chosen to enhance the properties of the final molded object. For example, if one of the interior layers is a gas scavenger, the chosen position of the gas scavenger layer may be the innermost interior layer to reduce the permeation rate of gas through the outer layers of the container into the scavenger, and to increase the rate of gas scavenging from the contents of the container. Such a position may extend the shelf life of the container contents if the purpose of the scavenger layer is to absorb gas permeating from the atmosphere exterior to the container. As another example, the position of outermost interior layer may enhance the performance of a humidity-sensitive gas barrier layer, by moving the barrier layer away from the 100% relative humidity of the contents of a beverage that is to fill the container to a position in the wall that is closer to the lower relative humidity of the atmosphere surrounding the container.

Optionally after molding, the preform may be processed to provide crystallization of the neck region while the remainder of the preform is left amorphous. This provides for good shape retention of the neck region during subsequent blowing operations without negatively impacting the preform's ability to be blown into its final shape. The preform is then formed into a container in a blow molding operation as described below. The preform is held in a clamping unit and is heated and biaxially expanded by axial stretching (i.e. along its length) and radial stretching. In most cases, the blowing operation is performed in the presence of a mold with interior dimensions (that is, an internal volume) greater than the external dimensions of the preform and equal to the external size and shape of the desired final shaped article, wherein the stretching is carried out by application of air pressure and mechanical pressure to the interior of the preform to provide a shaped article with external dimensions complementary to the internal dimensions of the mold. The neck region is unaffected by the blow molding operation while the bottom and particularly the walls of the preform are stretched and thinned. For multilayer containers, the resulting thickness of the exterior layers and the interior layers still provide sufficient strength and barrier properties to allow the container to contain and protect the product packaged within.

The blowing operation is usually performed using a core rod. The core rod may stabilize the preform in the proper orientation in the mold cavity and may be used to help heat the preform as it is blown. The axial stretching is done mechanically by inserting the core rod into the preform and mechanically extending it towards the bottom of the mold. Radial stretching is accomplished by injecting a compressed gas into the preform, thereby forcing the resin outward to contact the interior surface of the mold. In many cases, a preliminary radial stretch is preformed by injecting a first increment of gas. This makes room for the stretcher core rod, which can then be inserted. A preliminary radial stretch may also be useful to allow nucleation of the amorphous material so that it may develop greater crystallinity as it cools after stretching. The preform is then axially stretched by the rod and immediately afterward is blown with more gas to complete the blow molding operation.

The axial strain (or axial stretch ratio) may be about 1.5 to about 3.5, especially about 2 to about 3. The axial strain is considered to be the ratio of the container length to preform length. The radial or “hoop” strain (or hoop stretch ratio) is typically from about 2 to about 5, especially 3 to about 5, and is considered to be the ratio of the container circumference to that of the preform. Hoop strain is generally not constant for any particular container, as the container generally does not have a constant circumference. Hoop ratio, as used herein, refers to the average hoop ratio for the side walls of the container.

Areal strain (or areal stretch ratio) is the product of axial strain times hoop strain, and may be in the range of about 3 to about 17.5, such as from about 3 to about 15, about 5 to about 12 or about 8 to about 11.

There are two types of stretch-blow-molding techniques. In the one-stage process, preforms are injection molded, conditioned to the proper temperature, transferred to the stretch blow molding operation and blown into containers all in one continuous process, wherein the preform is not cooled below its softening temperature prior to stretching. This technique is most effective in specialty applications, such as wide-mouthed jars, where very high production rates are not a requirement.

In the one-step process, the preform from the injection molding process is transferred to the stretch blow molding step while the preform is at a temperature at which the preform becomes soft enough to be stretched and blown, again preferably above the Tg of the resin and below the crystallization temperature, such as from about 80 to about 120° C., or from about 80 to about 110° C. The preform may be held at that temperature for a short period prior to molding to allow it to equilibrate at that temperature. The mold temperature in the one-step process may be above or below the Tg of the PHA resin.

In “cold mold” process, blow mold temperatures are held below the Tg of the composition, such as from about 30 to about 50° C., or from about 25 to about 45° C. Sections of the mold such as the base where a greater wall thickness is desired may be maintained at even lower temperatures, such as from 0 to about 35° C., or from about 5 to about 20° C.

In “hot mold” process, the mold temperature is maintained somewhat above the Tg of the resin, such as from about 65 to about 100° C. In the “hot mold” process, the blow molded shaped article may be held in the mold under pressure for a short period of time (such as 1 to 20 seconds) after the molding is completed to allow the composition to develop additional crystallinity and allow for relaxation of stretched amorphous molecules (heat setting). The heat setting tends to improve the dimensional stability and heat resistance of the molded container while still maintaining good clarity. Heat setting of ISBM bottles is becoming more common, such as for hot-filled bottles and bottles that are going to be pasteurized.

The other main type of ISBM process is a two-step process in which the preform is prepared ahead of time and the preform is reheated to conduct the stretch blow molding step. In the two-stage process, preforms are injection molded, allowed to cool to a temperature below the Tg of the composition (for example by being stored at ambient temperatures, such as about 20 to 30° C., for a short period of time, such as 1 to 4 days) before bringing the preform to a temperature between the Tg and the temperature of crystallization from the glass or cold crystallization of the composition, and then blown into containers using a reheat-blow (RHB) machine. Because of the relatively high cost of molding and RHB equipment, this is the best technique for producing high-volume items such as carbonated beverage bottles.

The two-step process has the advantage of faster cycle times, since the stretch blow molding step does not depend on the slower injection molding operation to be completed. However, the two-step process requires reheating the preform to the stretch blow molding temperature. This may be done using infrared heating, which provides radiant energy to the outside of the perform. Conditions are desirably selected to heat the interior of the preform to a suitable molding temperature without overheating the outside. The result is that the two-step process usually has a smaller operating window than the one-step process.

In the two-step process, the preform can be heated to a temperature at which the preform becomes soft enough to be stretched and blown (such as above the Tg of the PHA resin and below the crystallization temperature), then blown using high pressure air into the final desired shape. A preferred temperature is from about 70 to about 120° C. and, more preferred, from about 80 to about 110° C. To help obtain a more uniform temperature gradient across the preform, the preform may be maintained at these temperatures for a short period to allow the temperature to equilibrate. Mold temperatures in the two-step process are generally below the Tg of the PHA resin (a “cold mold” as described above).

Heat setting using a heated mold may also be used in a two-step process, but has previously been used less often because the heat setting tends to increase cycle times.

Either the one-step or two-step process may include a “double” blowing operation in which the heated preform is blown oversize in a heated primary blow mold and heat set by contact with the primary blow mold, and then reheated and blown into the final shape. An example machine capable of performing these operations is a Model HSB-10, available from Nissei ASB Machine Co. Ltd., Japan.

Blowing gas pressures in either the one-step or two-step processes may range from about 5 to about 50 bar (about 0.5 to about 5 MPa), such as from about 8 to about 45 bar (about 0.8 to about 4.5 MPa). It may be useful to use a lower pressure injection of gas in the preliminary radial stretch, followed by a higher pressure injection to complete the blowing process.

The compositions described herein allow for heat-setting to occur at much shorter time durations, providing articles with much better heat stability with minimal increase in cycle times.

A representative process for producing an article such as container or bottle includes (i) preparing a composition as disclosed herein; (ii) injection molding or extrusion molding a closed-end hollow preform; (iii) (re)heating the preform to the blow molding temperature, such as about 5° C. to about 30° C. above, or about 10° C. to 20° C. above, the Tg range of the preform material; (iv) stretching the preform axially in the blow mold by means of a stretch rod; and (v) simultaneously with the axial stretching, introducing compressed air into the preform so as to biaxially expand the preform outwardly against the walls of the blow mold so that it assumes the desired configuration.

The modified PHA compositions described herein may be used to produce dimensionally-stable ISBM bottles with improved toughness, having less shrinkage in height and diameter than bottles prepared from a corresponding unmodified PHA resin. The article such as a bottle disclosed above has reduced heat deformation or shrinkage and improved toughness compared to an article made from unmodified PHA, when the article is aged at high temperature of about 30 to about 55° C. or about 35 to about 45° C. and at a high relative humidity of from about 60 to about 100, about 70 to about 100, or about 80 to about 95%. In other words, the article is a heat stable article where the article is substantially the same as an article made from PET in terms of heat deformation or shrinkage.

Of note are compositions having Tg from about 45 to about 90° C. and the temperature of crystallization from the glass or cold crystallization (Tcg or Tcc) is from about 70° C. to about 170° C., as determined by differential scanning calorimetry by heating from room temperature to 280° C. using a heating rate of 10° C./min, holding at 280° C. for two minutes, cooling to below room temperature, and then reheating from room temperature to 280° C. Also of note are compositions wherein the Tg is from about 45 to about 80° C. and the Tcg is from about 70 to about 130, and compositions wherein the Tg is from about 65 to about 80° C. and the Tcg is from about 90 to about 150. Of note are compositions wherein the melting point of the PHA polymer is from about 100 to about 170° C.

The shaped articles (e.g., preforms and bottles) may comprise materials other than the PHA blend, such as layers of polymeric material other than the PHA blend. For example, articles may be prepared by coinjection molding as described above wherein multiple melt streams are injected into a mold in such a way that one polymer is on the exterior of the article while at least one additional layer is in the interior.

Vials, bottles, jars and other containers comprising the modified PHA composition may be prepared, for example by injection-stretch-blow-molding. Bottle and/or jar sizes may range from under 2-ounce to 128-ounce capacity or larger. Although containers are generally described herein as bottles, other containers such as vials or jars may be prepared as described herein from the compositions described herein. Larger capacity containers such as drums or kegs may be similarly prepared, as are smaller vials, bottles and other containers.

Clarity is conveniently expressed in terms of % haze, which can be measured according to ASTM D-1003. Bottles or other containers produced as described herein preferably have a haze of ≦20%, ≦15%≦10% or ≦5%.

### EXAMPLES

### Materials Used

PLA2002D pellets (NatureWorks LLC; Minnetonka, Minn. USA), had a major portion of L-lactide and about 4.3 to 5% “non L-lactide”, a melt viscosity about 1500 Pa-s (190° C. and 100 s⁻¹), a Tg of 55° C., a melt point maximum endotherm at 150° C., and crystallinity generated with a second 10° C./minute heating of pellets previously heated to complete melting at 250° C. and cooled to 20° C. of about 0.5 J/g. Crystallinity generated in pellets of PLA2002D annealed for 19 hours at 145° C. is 40 J/g; hence, about 40% upper limit of crystallinity for this resin based on the pure crystal being about 100 J/g (references: Sarasua J R, Prud'homme R E, Wisniewski M, Le Borgne A, Spassky N. Macromolecules 1998; 31:3895).
PLA4032D pellets (NatureWorks LLC) had a Tg of 58° C., a melt point maximum endotherm at 166° C., and heat-up crystallinity of about 6 J/g (generated with a second 10° C./minute heating of pellets previously heated to complete melting at 250° C. and cooled to 20° C.) making it a faster crystallizing PLA than PLA2002D. PLA4032 had about 1 to 2% D-lactide.
CRODAMIDE® BR was “refined behenamide” (Croda Inc., Edison, N.J.) with melting point of 225 J/g at 119° C.
KEMAMIDE® B was a behenamide (Chemtura Corporation, Middlebury, Conn.) with melting point of 240 J/g at 114° C.
Stearamide: octadecanamide available (Sigma-Aldrich Corp, St. Louis, Mo.).

### Irgafos® 168 (Ciba Specialty Chemicals (Tarrytown, N.Y. USA)).

EBAGMA was an autoclave-produced ethylene n-butyl acrylate glycidyl methacrylate terpolymer (66.75 wt % ethylene, 28 wt % n-butyl acrylate, 5.25 wt % glycidyl methacrylate) with melt index 12 g/10 minute, 190° C., 2.16 kg load, melting range 50° C. to 80° C.)
Mod-1: A melt blend of a 1:1 (by weight) mixture of EBAGMA and behenamide, extruded and formed into pellets.

### Equipment and Methods

Batch blending was accomplished on a Haake Rheocord 9000 using roller blade rotors and a 55-g mixing chamber operated by preheating the unit to goal melt temperature, then running rotors, starting the clock, charging about 55 g of ingredients within about a 15 second period, closing the lid, and recording the torque, time, and melt temperature. When complete the melt mass was discharged onto a cold container, cooled to ambient and sealed.

Differential Scanning Calorimetry (DSC) was used to determine Tg, temperature of crystallization from the glass or cold crystallization (Tcc), crystallization from the melt, and melting point (Tm). A sample (4-9 mg) of polymer was analyzed using a TA Instruments (New Castle, Del.) Model Q1000 for heating from room temperature to 250° C. (in the case of PLA) using a heating rate of 10° C./min, then cooling the sample to ambient or about 20° C. at 10° C./min and then reheated 10° C./min to 250° C. Procedures for measurement of Tg, Tcc, and Tm were used as described in the TA Instruments manual for the 2920 DSC.

The first heat generates a crystallization exotherm when the polymer crystallizes at Tcc and at higher temperatures an endotherm is generated that is the polymer crystals melting at Tm. The “J/g” for the endotherm minus the “J/g” for the exotherm is an approximate measure of the amount of crystallinity in the original sample expressed in “J/g”. 100 J/g may indicate approximately 100% crystalline PLA, based on descriptions in R. E. Drumright et al, Advanced Materials 2000 12, (23), p. 1841 and Z. Kulinski, et al, Polymer 2005, 46, pp. 10290-10300). Lower amounts of J/g indicate less crystallinity, with the value of J/g roughly proportional to the % crystallinity.

In order to simulate the effects on the compositions during a two-stage ISBM operation, sheets of the compositions were prepared in batches and rapidly quenched to provide sheets of thick amorphous material, that is with a crystallinity content less than about 15 J/g and preferably less than 5 J/g. Sheets of amorphous material were prepared by compression molding 4 to 10 grams samples of resin. Rapidly Quenched Sheets having a uniform of 10 mils (0.25 mm) and dimensions of 2×2 in (5.1×5.1 cm) were prepared by compressing the PLA compositions between sheets of smooth aluminum foil in a press at a temperature between 190° C. and 220° C. and a pressure of about 6000 psi (414 bar). A stainless steel frame, 0.25 mm thick, with square openings was used to constrain the melted resin in place. The foil/frame/film structures were transferred to a direct, two-side contact cooling mold maintained at about 22° C. for fast quenching.

Alternatively, continuous melt blending and amorphous sheet extrusion were accomplished on a Werner&Pfleiderer (W&P process) 28 mm trilobal twin screw extruder with coat hanger die and quench drum. The extruder used an 830 mm long screw. Pellets and additives as a combined mixture entered about 70 mm from the top of the screw as a solid mixture at about 10 kg/hr to 20 kg/hr using a Foremost volumetric pellet feeder. The screw used forward conveying segments for most of its length and about 20% of its length used kneading blocks. The unit was run at 125 rpm with a melt temperature of 190° C. to 210° C. The melt passed through a coat hanger die (20 cm width and a 0.76 mm die gap). The melt curtain fell vertically about 5 cm to a quench drum cooled to 10° C. to 23° C. The drum rotation speed was set to minimum melt draw. Sheet thickness was controlled between about 250 micron and about 750 micron by varying the throughput rate of the polymer feed.

One-way stretched samples were accomplished by cutting uniformly wide strips (usually 2.5-cm) from the cooled, compression molded or extruded amorphous sheets. The strips were heated by direct contact on both sides with a pressure less than about 1 Ib/in². After heating a stretching force of about 100-200 psi was applied to the sample. Stretching was completed in about 1 to 8 seconds for heated sample lengths of about 4 to 6 inches. The stretched sample was immediately cooled by direct contact with a 22° C. metal surface while under a 100-200 psi constraining force.

Shrinkage was measured as a percentage change in machine direction (stretch direction) length when an unconstrained sample was exposed to 60° C. water for 30 seconds.

Shown in Table 1 are four compositions that were prepared from the components listed above by melt blending the ingredients using a Haake mixer (Model 9000 Plastograph) for 6 minutes at 210° C. and 125 rpm rotor speed under a nitrogen blanket. CE denotes comparative.

TABLE 1

| Sample | CE1 | CE2 | CE3 | E1 |
|---|---|---|---|---|
| PLA4032 (g) | 100 | 53.9 | 53.9 | 52.9 |
| CRODAMIDE ® BR (g) | — | 1.1 | — | 1.1 |
| EBAGMA (g) | — | — | 1.1 | 1.1 |

Rapidly Quenched Sheets were prepared from the compositions of CE1-3 and E1 by compression molding as described above.

The percent elongation at break of the sheets was measured according to ASTM D-638 using an Instron Series IX instrument (Instron Corp, Norwood, Mass.). Specimens were in a Type IV shape with “w” at 0.18 in (0.46 cm), “L” at 0.5 in (1.27 cm), and “L0” at 1.5 in (0.38 cm) and the test speed was 2 in/min (5.1 cm/min). Results are tabulated in Table 2, where the average percent elongation at break for CE1 was the result of three tests and the average percent elongation at break for CE2-3 and E1 was the result of eight tests.

The data indicate that the percent elongation at break remained substantially the same when behenamide was added to the PLA compositions (CE2 vs. CE1). The percent elongation at break of the PLA increased by 690% in the samples when EBAGMA was added to the composition (CE3 vs. CE1). The percent elongation at break increased by 2552% when both behenamide and EBAGMA were added to the composition (E1 vs. CE1). This demonstrates the excellent stretchability possible for a preform made of a PLA composition modified by behenamide and EBAGMA.

TABLE 2

| Elongation at Break, % | CE1 | CE2 | CE3 | E1 |
|---|---|---|---|---|
| Sample 1 | 3.1 | 9.8 | 2.9 | 213 |
| Sample 2 | 3.6 | 7.1 | 2.7 | 2.9 |
| Sample 3 | 2.8 | 10.8 | 2.8 | 3.4 |
| Sample 4 | — | 2.5 | 181 | 70 |
| Sample 5 | — | 8.1 | 2.7 | 7.4 |
| Sample 6 | — | 2.4 | 2.3 | 3.1 |
| Sample 7 | — | 1.5 | 2.7 | 160 |
| Sample 8 | — | 2.3 | 5.2 | 219 |
| Average Value | 3.2 | 5.56 | 25.29 | 84.85 |
| Standard Deviation | 0.4 | 3.79 | 62.92 | 97.33 |
| Standard Deviation % | 12 | 68 | 248 | 114 |

Using the same melt blending procedure as described for Examples CE1-3 and E1, two PLA compositions (CE4 and E2) were prepared from the ingredients shown in Table 3.

TABLE 3

| Sample | CE4 | E2 |
|---|---|---|
| PLA4032 (lb) | 4 | 3.9 |
| Stearamide (lb) | — | 0.08 |
| EBAGMA (lb) | 0.08 | 0.08 |

Using the same compression molding process described above for Examples CE1, CE2, CE3 and E1, Rapidly Quenched Sheets having a thickness of 22 mils (0.56 mm) were made from the compositions of CE4 and E2 and their percent elongation at break was determined according to ASTM D-638. Results are tabulated in Table 4.

In comparison to the PLA composition containing only EBAGMA as an additive (CE4), the presence of both EBAGMA and stearamide in E2 increased the percent elongation at break of the composition by 200%.

TABLE 4

| | CE4 | E2 |
|---|---|---|
| % Elongation at Break | 4 | 12 |
| (Average) | | |
| % Elongation at Break | 5 | 24 |
| (Maximum of 3 samples) | | |

Nearly amorphous sheet samples of PHA were prepared by the W&P process (above) of the thicknesses (in mils) shown in Table 5.

TABLE 5

| Example | Thickness | Composition |
|---|---|---|
| CE5 | 31 | 100% PLA4032D, no additive |
| E3 | 30 | PLA4032D + 1% behenamide + |
| | | 1% EBAGMA |
| CE6 | 24 | 100% PLA2002D, no additive |
| E4 | 21 | PLA2002D + 2% behenamide + |
| | | 0.6% IRGAFOS ® 168 + 0.5% EBAGMA |
| E5 | 21 | PLA2002D + 2% behenamide + |
| | | 0.6% IRGAFOS ® 168 + 2% EBAGMA |

Samples of about 1 cm by 1 cm were contacted on both sides by the platens of a press at 110° C. and with a pressure of less than 20 psi for 2 to 40 seconds (time uncertainty was 1 second) to avoid stretching of the samples. The samples were immediately (faster than about 0.5 seconds) removed and cooled to ambient. The amount of crystallinity developed was determined by DSC as described above (e.g. melting endotherm minus previous crystallization exotherm) and summarized in Table 6.

TABLE 6

| Run | Heating at 110° C. (sec) | Crystallinity after heating (J/g) |
|---|---|---|
| CE5 | 0 | 0.1 |
| CE5 | 10 | 1 |
| CE5 | 20 | 1 |
| CE5 | 40 | 0.4 |
| E3 | 0 | 16 |
| E3 | 10 | 15 |
| E3 | 20 | 18 |
| E3 | 40 | 21 |
| E4 | 0 | 2.5 |
| E4 | 2 | 11 |
| E4 | 5 | 3 |
| E4 | 20 | 11 |
| E4 | 40 | 16 |

Table 6 shows that unstretched, nucleated composition E3 had much higher crystallinity than the comparative non-nucleated composition CE5, which did not exhibit significant crystallinity even with extended heating. The composition with slower-crystallizing PLA2002 (E4) required more than about 40 seconds to develop an additional 15 J/g or more of crystallinity versus 40 J/g or more maximum, even with modifiers.

To simulate the stretching that occurs during the stretch blow molding process and its additive effect on the crystallization rate, amorphous sheets, about 12 inches wide, of the above compositions were made using the W&P process described above. Along the transverse to flow direction, parallel inked lines were marked at intervals of 1 cm. The sheets were then cut to make about 1-inch wide strips. One end of the 1-inch strip of sample was taped away from where strip was to be heated (with heat resistant tape). The mold included two (2) brass stretching plates (about 15 cm×15 cm×4 mm) heated in a press to 110° C. A brass quench plate of the same dimensions simulating a cooled mold was maintained at about 22° C. Each sample was directly contacted with the two hot plates for 5 to 10 seconds. The top plate was removed and the sheet was stretched for about 2 to 4 seconds. The plates were immediately quenched at about 22° C. for about 10 seconds while constrained from shrinking in the machine direction. The stretched samples were measured for their precise stretch ratios by observing the change in the machine direction length from the original 1-cm markings in the machine direction. Shrinkage measurements were accomplished by re-marking the stretched sample with 1-cm markings in the machine direction. The samples were exposed without constraint to 60° C. water and the shrinkage recorded by comparing the spacing between marking after exposure to the original 1-cm spacing.

TABLE 7

| | | Crystallinity | Shrinkage |
|---|---|---|---|
| Example | Stretch | (J/g) | (%) |
| CE5 | 1.1x | 2 | 24 |
| CE5 | 2.3x | 22 | 28 |
| E3 | 1x | 20 | 10 |
| E3 | 2.5x | 27 | 3 |
| CE6 | 0.5x | NA | 6 |
| CE6 | 1x | NA | 17 |
| CE6 | 1.4x | 1 | 17 |
| CE6 | 3.7x | 5 | 35 |
| E4 | 1.4x | 11 | 13 |
| E4 | 2x | 16 | 12 |
| E5 | 0x | 3.5 | |
| E5 | 0x | 11 | |
| E5 | 0.8x | 19 | |
| E5 | 1.5x | 18 | |
| E5 | 2.4x | 24 | |
| E5 | 3.2x | 25 | |

The results are shown in the Table 7 (“1×” means the original length was doubled during the stretch process and “2×” means the original length was tripled). Table 7 shows that higher crystallinity was generated with stretching. As the stretch ratio was increased, crystallinity also increased. Samples containing modifier (E3 or E4 and E5) generated higher crystallinity for given stretch ratios than samples without modifier (respectively CE5 or CE6). Since stretch blow molding usually encompasses areal (the product of radial or circumferential) stretch ratios greater than the linear stretch ratios summarized in Table 7, higher levels of crystallinity may be obtained. Nevertheless, the use of the nucleators also favored crystallinity. Compared to non-nucleated samples, the crystallinity of nucleated samples is higher and the shrinkage was reduced, although not lowered all the way to 0%. For example composition E3 stretched at 2.5×, had high crystallinity and low shrinkage of 3% but not 0%. Therefore Table 7 also shows that within a wide range of stretch ratios, high crystallinity alone does not guarantee low shrinkage. Table 7 in combination with Table 6 also shows that a stretching process is required to achieve crystallinity in short time periods, such as in 2 seconds versus 40 seconds for unstretched samples (Table 6).

In a separate run using nucleated and non-nucleated compositions of the slower-crystallizing PLA, sheets were oriented and quenched as above except a next step of heat setting was applied to the sheets. For heat setting, the sheets were constrained from shrinking in the direction of their stretch and while being exposed to 100° C. for specific time periods. These sheets were then quenched to 22° C. Their crystallinity (J/g) and 60° C. shrinkage (%) are shown in Table 8.

TABLE 8

| | | Heat Set Time | | | | | |
|---|---|---|---|---|---|---|---|
| | | 10 seconds | | 20 seconds | | 40 seconds | |
| Example | Stretch | Crystallinity | Shrinkage | Crystallinity | Shrinkage | Crystallinity | Shrinkage |
| CE6 | 1.4x | — | — | 0 | 20 | 1 | 20 |
| CE6 | 3.7x | — | — | 5 | 27 | 17 | 27 |
| E4 | 1.4x | 14 | 13 | 14 | 10 | — | — |
| E4 | 2x | 18 | 13 | 22 | 0 | — | — |

Table 8 shows that heat setting at 100° C. was effective at reducing the shrinkage especially for samples oriented above 2× and when nucleation is present. Heat setting for longer than 10 seconds gave shrinkages approaching 0%. This suggests that use of a hot mold in the blowing step of an ISBM process may be useful for these PLA compositions. Such a process would involve holding the sample in the hot mold while retaining it under pressure to constrain it from shrinking during the heat treatment process. In an ISBM process, because of the higher stretch ratios, crystallinity may be improved and shrinkage may be reduced even further, even with short heat set times.

In another run, samples were oriented about 2-fold (i.e. about 1×) using a variety of orientation temperatures. The films were quenched and not heat-set and the shrinkages were measured as shown in Table 9.

TABLE 9

| | | Stretch Temp | | |
|---|---|---|---|---|
| Example | Stretch | (° C.) | Crystallinity (J/g) | Shrinkage (%) |
| CE6 | 1x | 80 | 0 | 48 |
| E4 | 1.3x | 80 | 6 | 53 |
| CE6 | 0.9x | 65 | 4 | 48 |
| E4 | 0.9x | 65 | 8 | 48 |
| CE6 | 2x | 110 | NA | 29 |
| CE6 | 0.9x | 130 | 1 | 5 |
| E4 | 1.1x | 130 | 7 | 6 |

Table 9 shows that higher temperature orientation was beneficial for lower shrinkage but crystallinity of the sample was low. Without heat setting, even with nucleators, the shrinkage could not be lowered to 0% by adjusting stretching temperature alone.

Heat setting durations of longer than 20 seconds (as exemplified in Table 8 for the lower stretch ratios) are impractically long for commercial stretch blow molding operations. In a continuation of the above run, samples were heat set at slightly below 100° C. for various time durations between 5 and 90 seconds. The resulting samples were tested for 60° C. shrinkage.

TABLE 10

| | | Stretch | | | |
|---|---|---|---|---|---|
| | | Temp | Heat Set Time | | Crystallinity² |
| Example | Stretch | (° C.) | (seconds/shrinkage) | | (J/g) |
| CE6 | 0.9x | 65 | 9/13% | 40/13% | 2 |
| E4 | 1.0x | 65 | 5/13% | 10/0% | 17 |
| CE6 | 0.9x | 80 | 20/23% | 40/7% | 9 |
| E4 | 1.1x | 80 | 5/3% | 21/0% | 21 |
| CE6 | 0.9x | 130 | 40/7% | 90/5% | 0 |
| E4 | 1.1x | 130 | 10/3% | 19/0% | 16 |

²For sample after heat setting in adjacent column (J/g).

Table 10 shows that shrinkage is considerably reduced and crystallinity increased even with considerably shorter heat set times for nucleated, toughened PLA compared to non-modified PLA. Even slower-crystallizing PLA2002D could be heat-set to 0% shrinkage when nucleated using short heat set durations at 100° C. if orientation is not conducted at too high a temperature. A mold temperature slightly below 100° C. is a convenient heat setting temperature because it involves running hot water through the molds instead of either water/glycol mixtures or the use of pressured hotter water.

Additional heat setting tests were run below 100° C. and various durations. The samples were tested for shrinkage at 60° C. and the results are shown in Table 11.

TABLE 11

| | | Stretch | Heat Set | Heat Set | |
|---|---|---|---|---|---|
| | | Temp | Temp | Time | Shrinkage |
| Example | Stretch | (° C.) | (° C.) | (second) | (%) |
| E4 | 0.9x | 80 | 61 | 60 | 48 |
| E4 | 1x | 80 | 70 | 40 | 37 |
| E4 | 1x | 80 | 80 | 30 | 23 |
| E4 | 1x | 80 | 80 | 10 | 27 |
| E4 | 1.1x | 130 | 80 | 10 | 6 |

Table 11 shows that at lower stretch temperatures (80° C.) and lower heat setting temperatures (greater than 15° C. below the average of Tg and Tmelt) low shrinkage was not achieved within 30 seconds.

TABLE 12

| | | | | Dimensions | |
|---|---|---|---|---|---|
| | Weight % | | | Lay flat | Thickness |
| Example | Mod-1 | EBAGMA | Kemamide B ® | (cm) | (mil) |
| CE7 | 0 | 0 | 0 | 8.0 | 2 to 3 |
| E6 | 2 | 0 | 0 | 8.5 | 1 to 2 |
| E7 | 4 | 0 | 0 | 8.5 | 1 to 2 |
| CE8 | 0 | 1 | 0 | 5.3 | 3 to 4 |
| CE9 | 0 | 2 | 0 | 6 | 2 to 3 |
| CE10 | 0 | 0 | 1 | 6.3 | 2 to 3 |
| CE11 | 0 | 0 | 2 | 6 | 3 to 4 |

Pellets of PLA4032 and Mod-1 were dry blended in the amounts summarized in Table 12 and blown films were prepared according to the following procedure. The pellets were extruded into blown film using a 1.9-cm single (25:1 L:D) screw extruder sold by C.W. Brabender Instruments, Inc (South Hackensack, N.J.) feeding a circular die (2.5 cm diameter). The 50-cm long screw had an 8-cm mixing section at its terminus. Take-off speed was about 2 inches/second. The barrel was set to 200° C. and with the screw operating at 27 rpm, and the melt temperature was 205° C. These films were made in a way that their increase of diameter appeared to happen before the frost line was created. That is, the orientation occurred at or above the melt temperature of the composition, when it was still liquid.

TABLE 13

| | DSC Analysis | | |
|---|---|---|---|
| | | | Amount of |
| Example | Exotherm (J/g) | Endotherm (J/g) | crystallization (J/g) |
| CE7 | 40.7 | 41.7 | 1 |
| E6 | 27.5 | 32.8 | 5.3 |
| E7 | 18.1 | 33.6 | 15.5 |
| CE8 | 40.9 | 41.4 | 0.5 |
| CE9 | 42 | 42 | 0 |
| CE10 | 40 | 32 | 8 |
| CE11 | 39 | 32 | 7 |

The results in Table 13 indicate more crystallinity was obtained when Mod-1 (a combination of behenamide and EBAGMA) was added to PLA-1 compared to unmodified PLA-1 or PLA-1 modified with EBAGMA.

To simulate how the compositions would behave in an ISBM process, a simple uniaxial stretching test was performed. Ribbons were cut from the films in the Machine Direction in the sizes (W0, Th0) shown below in Table 14 and marked at 1-cm intervals (L0) along the machine direction. The films were heated by direct contact on each film face with 110° C. plates over a length of 2 inches and then stretched uniaxially. The stretch rate provided about 14 inches of stretched film from a 2-inch wide zone of heated film in about 8 seconds. The final dimensions of the films were shown below as Wf, Thf and Lf (the new spacing between the marks). The stretch ratio was averaged as 700% (+/−100%). To test the shrink performance of the stretched films, samples of the stretched film were marked with 1 cm tick marks in the stretched direction, treated in one of three methods as described below, and exposed to 70° C. water for 30 seconds. The shrinkage was determined by measuring the spacing between the tick marks after the exposure and reported as a percentage.

(1) No heat setting. The stretched samples were not heat treated prior to the shrink test.

(2) “Short” heat setting: Film samples were heat treated for 1.5 seconds by direct contact on both sides to 110° C. heaters while the films were constrained from moving (shrinking) in the stretch direction.

(3) “Long” heat setting: Other film samples were heat treated as described in (2) for 10 seconds (+/−0.5 seconds).

TABLE 14

| | W0 | Th0 | L0 | Wf | Thf | Lf | % Shrink | | | |
|---|---|---|---|---|---|---|---|---|---|---|
| Example | (cm) | (mil) | (cm) | (cm) | (cm) | (cm) | Stretch ratio | Method (1) | Method (2) | Method (3) |
| CE7 | 1.8 | 2.8 | 1 | 1 | 0.7 | 6.5 | 6.5 | 13 | | |
| CE7 | 1.8 | 2.7 | 1 | 1 | 0.7 | 6.5 | 6.5 | | 11 | |
| CE7 | 1.9 | 2.2 | 1 | 1 | 0.5 | 6.5 | 6.5 | | | 0 |
| E6 | 2 | 2.4 | 1 | 1.2 | 0.4 | 7 | 7 | 12 | | |
| E6 | 1.7 | 2.7 | 1 | 1.5 | 0.5 | 7 | 7 | | 7 | |
| E6 | NA | 2.7 | 1 | NA | 0.6 | 7 | 7 | | | 0 |
| E7 | 3 | 1.8 | 1 | 1.8 | 0.4 | 5.7 | 5.7 | 13 | | |
| E7 | 3 | 1.9 | 1 | 1.8 | 0.4 | 5.7 | 5.7 | | 6 | |
| E7 | 3 | 2.2 | 1 | 2 | 0.3 | 5.7 | 5.7 | | | 0 |

Non-heat set films all showed at least 12% shrink. Heat treatment for 10 seconds provided dimensionally stable films. For short duration heat treatment, the film of nonmodified PLA showed no real difference in shrink performance. The film samples containing Mod-1 gave desirably lower shrinkages at 70° C. when subjected to short heat setting times.

The modulus was tested at 70° C. in the machine direction (MD) of these samples using an Instron and stamped-out dog-bone plaques of 0.188-inch test width, 0.87-inch test length and running at a rate of 1 inch/minute. Tensile testing of the original stretched films shows an increase in toughness as indicated by higher break strains.

TABLE 15

| | Modulus | | |
|---|---|---|---|
| | (Tangent at | Stress at | Strain at |
| Example | 0% strain) kpsi | Break (psi) | Break (%) |
| CE7 MD | 585 | 8160 | 22 |
| CE7 TD | 290 | 6885 | 13 |
| E6 MD | 367 | 8670 | 61 |
| E6 TD | 320 | 7140 | 60 |
| E7 MD | 275 | 7140 | 50 |
| E7 TD | 285 | 4590 | 50 |

The data in Table 15 shows the value of modifying PLA with EBAGMA for transverse direction toughness when stretching is accomplished in the machine direction. Bottles can have poor toughness in their radial (transverse) direction if too much stretching is done in the axial (machine) direction versus in the radial (transverse) direction. These examples show a good balance of physical properties when stretched at high stretch ratios.

### Bottle Production

Bottles are produced on a laboratory-scale Sidel SBO12 stretch-blow-molding machine. The temperature zones are set independently. A temperature sensor in zone three determines the temperature of the preform immediately prior to stretch-blow-molding. Bottles are prepared from a modified PLA resin as described herein in a two-step ISBM process as follows.

20-ounce bottles (using a 24.5-g preform) and 24-ounce bottles (using a 30-g preform) are also produced.

24-oz bottles are evaluated to determine thermal stability in contact with a personal-care formulation. For this study, KERI lotion (original formula) is used to represent a typical personal-care, hand-cream formulation. The height and diameter of each bottle are measured prior to aging. For each of the states evaluated, three bottles are left empty, three are filled with deionized water and three are filled with KERI lotion. The bottles are aged for 42 days in a room that is maintained at 37.8° C. (100° F.) and 90% relative humidity. Bottles are measured to determine shrinkage in height and diameter after 2 days, 13 days and 42 days.

1.5-L bottles are prepared. Preforms having a length of 129 mm, an average diameter of 23 mm

and weights of 42 to 44 grams are injection molded by heating the resin to a temperature of 200 to 210° C. and injecting it into a preform mold. The molding conditions are optimized to produce minimal part stress and to produce clear parts free of haze. The molded preforms are cooled to room temperature before stretch blow molding in a separate step.

Stretch blow molding is performed on a laboratory scale machine capable of producing approximately 2400 bottles/hour at full rates. The preforms are heated with infrared lamps to a temperature of about 98 to 110° C., inserted into the mold, pre-blown at a pressure of about 10 bar (1 MPa), and then stretched and blown at a pressure of 38 bar (3.8 MPa). The mold temperature is 100° F. (38° C.), except at the base of the mold which is chilled to 40° F. (4° C.). Stretch ratios are: axial stretch ratio=2.1; hoop stretch ratio=4.0; areal stretch ratio=8.4

Sixteen-ounce carbonated soft drink bottles. Preforms having a length of 68.2 mm, a reference inside diameter of 15.7 mm, a reference outside diameter of 22.4 mm and a weight of about 24 grams are injection molded by heating the resin to a temperature of 205 to 225° C. and injecting it into the preform mold.

Stretch blow molding is performed on a laboratory scale machine capable of producing approximately 1200 bottles/hour at full rates. The preforms are heated with infrared lamps to a temperature of about 85 to 90° C., inserted into the mold, pre-blown at a pressure of about 20 bar (2 MPa), and then stretched and blown at a pressure of 38 bar (3.8 MPa). The mold temperature is 120° F. (49° C.), except at the base of the mold which is chilled to 40° F. (4° C.). Stretch ratios are: axial stretch ratio=2.2; hoop stretch ratio=3.7; areal stretch ratio=8.1.

Preform temperatures are then varied to determine for each resin the range of preform temperatures at which good quality bottles can be prepared at the stated production rate. Bottle quality is evaluated by examining the bottles for the appearance of stress whitening, thin walls at the base, thin side walls and the development of a resin slug at the center of the base.

One-liter straightwall bottles. Preforms having weights of 29 grams are injection molded. The molded preforms are cooled to room temperature before stretch blow molding in a separate step.

Stretch blow molding is performed on a laboratory scale machine at a rate of approximately 1200 bottles/hour. The preforms are heated with infrared lamps to a temperature of about 83° C., inserted into the mold, pre-blown at a pressure of about 5 bar (0.5 MPa), and then stretched and blown at a pressure of 40 bar (4 MPa). The mold temperature is 100° F. (38° C.). Stretch ratios are: axial stretch ratio=2.3; hoop stretch ratio=4.35; areal stretch ratio=10.0.

The bottles are dimensionally measured for height, major diameters and overfill volume after aging for 24 hours at ambient conditions. The bottles are then subjected to 100° F. (38° C.) and 100% relative humidity for 24 hours, and the dimensions are re-measured to assess dimensional stability.

1. A process comprising preparing a thermoplastic composition; heating the composition to a melt; producing a film from the melt; and uniaxially stretching the film wherein
the composition comprises, based on the weight of the composition, about 50 to about 99.5% of a poly(hydroxyalkanoic acid), about 0.1 to about 40% of an ethylene ester copolymer, and about 0.05 to about 5% of a nucleator;
the ethylene ester copolymer comprises, based on the total weight of the ethylene ester copolymer, about 20 to about 95% of copolymerized units of ethylene, about 0.5 to about 25% of copolymerized units of one or more olefins of the formula CH₂═C(R¹)CO₂R², and 0 to about 70% of copolymerized units of one or more olefins of the formula CH₂═C(R³)CO₂R⁴;
R¹ is hydrogen or an alkyl group with 1 to 6 carbon atoms;
R² is glycidyl, based on the total weight of the ethylene ester copolymer;
R³ is hydrogen or an alkyl group with 1 to 8 carbon atoms;
R⁴ is an alkyl group with 1 to 8 carbon atoms, carbon monoxide, or of two or more combinations thereof;
the nucleator is a carboxylic acid or derivative thereof that does not cause poly(hydroxyalkanoic acid) depolymerization;
the preform has one closed end and one open end;
the stretching is carried out in axial direction, radial direction, or both;
the second mold has interior dimensions greater than the external dimensions of the preform and equal to the external size and shape of a desired final shaped article; and
the stretching is carried out by application of air pressure and mechanical pressure to the interior of the preform to provide the shaped article.

2. The process of claim 1 wherein the poly(hydroxyalkanoic acid) comprises polymerized units of one or more hydroxyalkanoic acids selected from the group consisting of 6-hydroxyhexanoic acid, 3-hydroxyhexanoic acid, 4-hydroxyhexanoic acid, 3-hydroxyheptanoic acid, glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, and 5-hydroxyvaleric acid.

3. The process of claim 1 wherein the poly(hydroxyalkanoic acid) is selected from the group consisting of poly(glycolic acids), poly(lactic acids), poly(hydroxybutyric acids), poly(hydroxybutyric acid-hydroxyvaleric acid) copolymers, and poly(glycolic acid-lactic acid) copolymers; and the stretching is in machine direction.

4. The process of claim 3 wherein the poly(hydroxyalkanoic acid) is poly(lactic acid).

5. The process of claim 4 wherein the poly(hydroxyalkanoic acid) is a stereo complex of poly(D-lactic acid) and poly(L-lactic acid).

6. The process of claim 3 wherein the poly(lactic acid) is a stereo complex of poly(D-lactic acid) and poly(L-lactic acid).

7. The process of claim 2 wherein the ethylene ester copolymer comprises, based on the total weight of the ethylene ester copolymer, about 40 to about 90% of copolymerized units of ethylene, about 3 to about 20% of copolymerized units of one or more esters of the formula CH₂═C(R¹)CO₂R², and about 3 to about 70% of copolymerized units of one or more esters of the formula CH₂═C(R³)CO₂R⁴.

8. The process of claim 7 wherein the ethylene ester copolymer comprises, based on the total weight of the ethylene ester copolymer, about 50 to about 80% of copolymerized units of ethylene, about 3 to about 17% of copolymerized units of one or more esters of the formula CH₂═C(R¹)CO₂R², and about 20 to about 35% of copolymerized units of one or more esters of the formula CH₂═C(R³)CO₂R⁴.

9. The process of claim 8 wherein the ethylene ester copolymer is an ethylene butyl acrylate glycidyl methacrylate terpolymer, an ethylene methacrylate glycidyl methacrylate terpolymer, or combinations thereof.

10. The process of claim 7 wherein the nucleator is selected from the group consisting of aromatic carboxylic acid, aliphatic carboxylic acid, fatty acid alcohol, aliphatic carboxylic acid ester, aliphatic carboxylic acid amide, polycarboxylic acid, aliphatic hydroxycarboxylic acid, and combinations of two or more thereof.

11. The process of claim 9 wherein the nucleator is an aliphatic carboxylic acid amide of an aliphatic carboxylic acid and the acid has 16 to 26 carbon atoms.

12. The process of claim 11 wherein the aliphatic carboxylic acid amide is selected from the group consisting of aliphatic monocarboxylic acid amide, N-substituted aliphatic monocarboxylic acid amide, aliphatic carboxylic acid bisamides, N-substituted aliphatic carboxylic acid bisamide, and N-substituted urea, and combinations of two or more thereof.

13. The process of claim 12 wherein the aliphatic carboxylic acid amide is behenamide.

14. A process comprising preparing a poly(lactic acid) composition into pellet form; heating the pellets to a melt in an extruder; producing a film from the melt; and uniaxially stretching the film wherein
the composition comprises, based on the weight of the composition, about 67 to about 99% of the poly(lactic acid), about 0.5 to about 20% of ethylene butyl acrylate glycidyl methacrylate terpolymer or ethylene methacrylate glycidyl methacrylate terpolymer, and about 0.1 to about 3% an amide selected from the group consisting of aliphatic monocarboxylic acid amide, N-substituted aliphatic monocarboxylic acid amide, aliphatic carboxylic acid bisamides, N-substituted aliphatic carboxylic acid bisamide, and N-substituted urea, and combinations of two or more thereof.

15. The process of claim 14 wherein the composition comprises about 89 to about 99% of the poly(lactic acid), about 1 to about 10% of the ethylene butyl acrylate glycidyl methacrylate terpolymer, and about 0.25 to about 1% of the amide; and the amide is behenamide.

16. The process of claim 15 wherein the stretching is in machine direction.

17. The process of claim 16 wherein the film is a blown film.

18. The process of claim 16 further comprising converting the film to an article wherein the article is a bottle, jar, or container.

19. The process of claim 15 wherein the stretching is carried out at high stretch ratios with an average of 700%.

20. The process of claim 19 wherein the film has reduced shrinkage as compared to a film made from a poly(lactic acid) composition containing no amide.
